(19) United States
(12) Patent Application Publication
(10) Pub. No.: US 2008/0002046 A1
(43) Pub. Date: Jan. 3, 2008

(54) Integrated Camera-Projection Device

(76) Inventor: Robert Wilhelm Schumann, Oakton, VA (US)

Correspondence Address: DAVID GROSSMAN, 518 WOODLAND CT. NW, VIENNA, VA, 22180, US

(21) Appl. No.: 11/428,024

(22) Filed: Jun. 30, 2006

(51) Int. Cl. H04N 5/222; G03B 13/02

(52) U.S. Cl. 348/333.1; 396/374

(57) ABSTRACT

A camera-projection device combines internal display and external projection of images in a portable electronic imaging device, such as a digital camera, a digital camcorder, a cell phone or a PDA. The same light source may be shared between an internal display and external projection and may be located internal or external to the camera-projection device. The same lens, such as a liquid lens, may be employed in image capture and image projection. The same display device may also be shared for internal display and external projection of the images.

### BACKGROUND OF THE INVENTION

In recent years, rapid technology developments have taken place in the field of digital photography and imaging. Portable electric imaging devices have popularized the market, in part, because of their convenience of use, flexibility, and portability. An electric imaging device refers to any device with digital image capturing capability, including but not limited to a digital camera, a digital camcorder, a cell phone and a PDA. In addition to a view finder, many image recording devices now have an on-device internal display which allows more than one person to preview and review pictures. This is an improvement from traditional film cameras, camcorders, and the like. However, limited by its small size, the display on an internal screen can only accommodate the viewing needs of a few people. For presentations of images to a larger group of viewers, a separate projector has conventionally been employed. However, projection devices are both expensive and inconvenient to use with a personal digital image device. Projection devices tend to be large in size and have many bulky assemblies, making them inconvenient to use to satisfy the instant viewing needs of a large group of viewers. What is needed is a convenient way to enable several people to view images from a portable digital recording device.

### BRIEF DESCRIPTION OF THE DRAWING(S)

The accompanying drawings, which are incorporated in and form a part of the specification, illustrate embodiments of the present invention and, together with the description, serve to explain the principles of the invention.

FIG. 1 shows an embodiment of an integrated camera-projection device, comprising an image capture unit, a first presentation device, and a second presentation device.

FIG. 2 is a block diagram of an aspect of an embodiment of a camera-projection device as per the present invention.

FIG. 3 is a block diagram showing another embodiment of the present invention.

FIG. 4 is a block diagram shows an aspect of an embodiment of a camera-projection device as per the present invention, where the same lens set is used for both image capture and image projection.

FIG. 5 is a block diagram showing a different aspect of the embodiment of the present invention shown in FIG. 4.

FIG. 6 is a block diagram showing an embodiment of the present invention where the same light source is used for internal display and external projection of images.

FIG. 7 is a block diagram showing an embodiment of the present invention, where the same set of lens is used for both image capture and projection and the same light source is used for internal display and external projection of images.

FIG. 8 is a block diagram shows an aspect of an embodiment of the present invention that uses a Digital Light Processor (DLP).

### SUMMARY OF THE INVENTION

The present invention is directed to a system for the combined internal display and external projection of images in a portable electronic imaging device, such as a digital camera, a digital camcorder, a cell phone or a PDA. An embodiment of the integrated camera and projection device having features of the present invention comprises an image capture unit 202, a digital signaling switch 245, and a first device first presentation device 230 and second presentation device 270. The image capture unit 202 may be configured to output a digital representation of at least one image. The digital signaling switch 245 can receive the digital representation and selectively output the digital representation to the first presentation device 230, or the second presentation device 270. In particular, the first presentation device 230 may be an internal display device and the second display device 230 may be an external projection device.

In another embodiment of the present invention, the same lens 410, which is configured to transmit and focus light on both sides of the lens 410, may be used to both capture an image and externally project an image. An optical switch may be employed to selectively receive light from either lens 410 or the display device 420 and to output the light to the image capture unit 202 or lens 410 respectively. The same display device 420 is also shared for the internal display of the image and the external projection of the image.

In another embodiment of the present invention, the same light source 260 may be shared for both the internal display of an image and external projection of the image. This light source may be either internal or external.

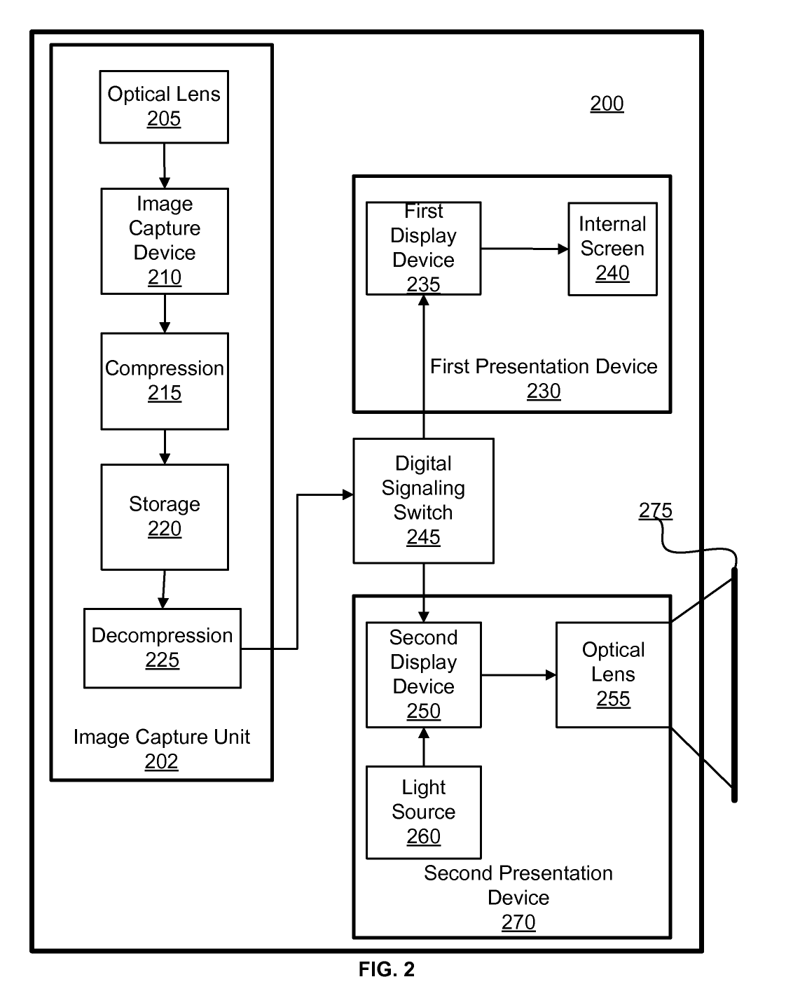

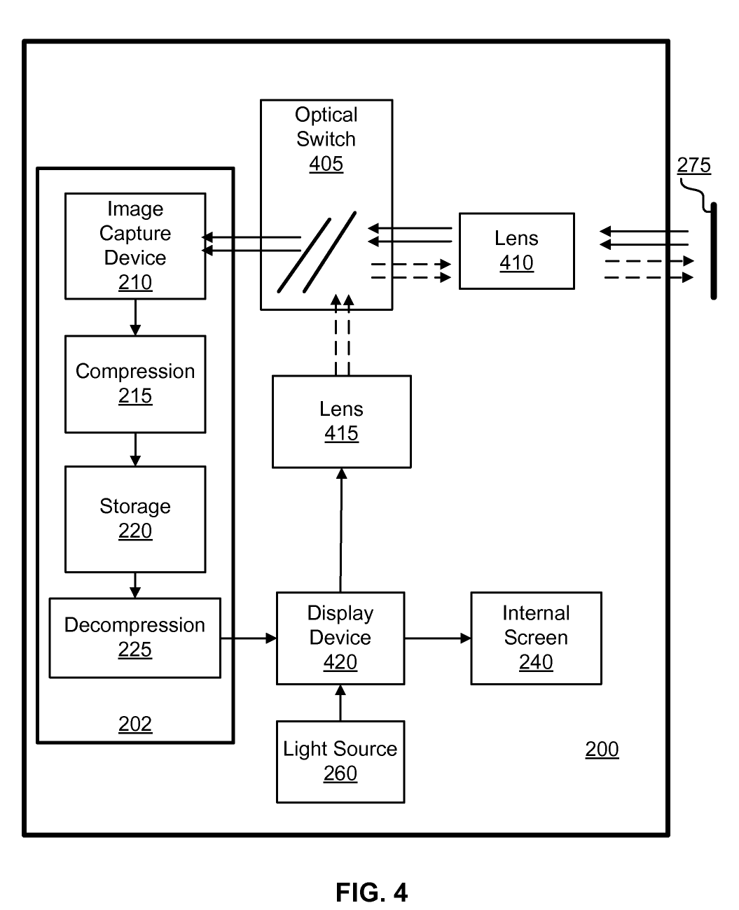

In yet another embodiment of the present invention, a DLP 810 may replace the digital signaling switch 245 and display devices 235 and 250 (as shown in FIGS. 2, 3 and 6) or replaces the display device 420, lens 415 and optical switch 405 (as shown in FIGS. 4, 5, and 7). It may carry out the combined functions of a switch (digital signaling or optical) and a display device.

These and other features, aspects, and advantages of the present invention will become better understood with reference to the following description and appended claims.

### DETAILED DESCRIPTION OF THE INVENTION

Throughout this description, the embodiments and examples shown should be considered as exemplars, rather than as limitations on the present invention.

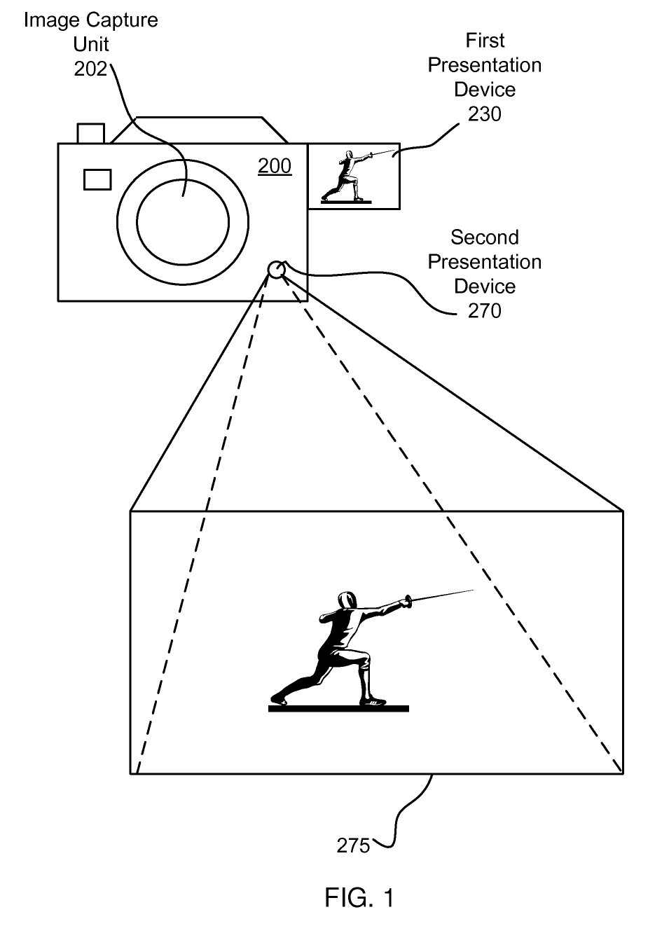

FIG. 1 is a illustrative drawing of an integrated camera and projection device 200 comprising an image capture unit 202, a first presentation device 230, a second presentation device 270 and a switching mechanism (not shown) which may change between the two display devices to display an image on either the internal screen or an external projection screen.

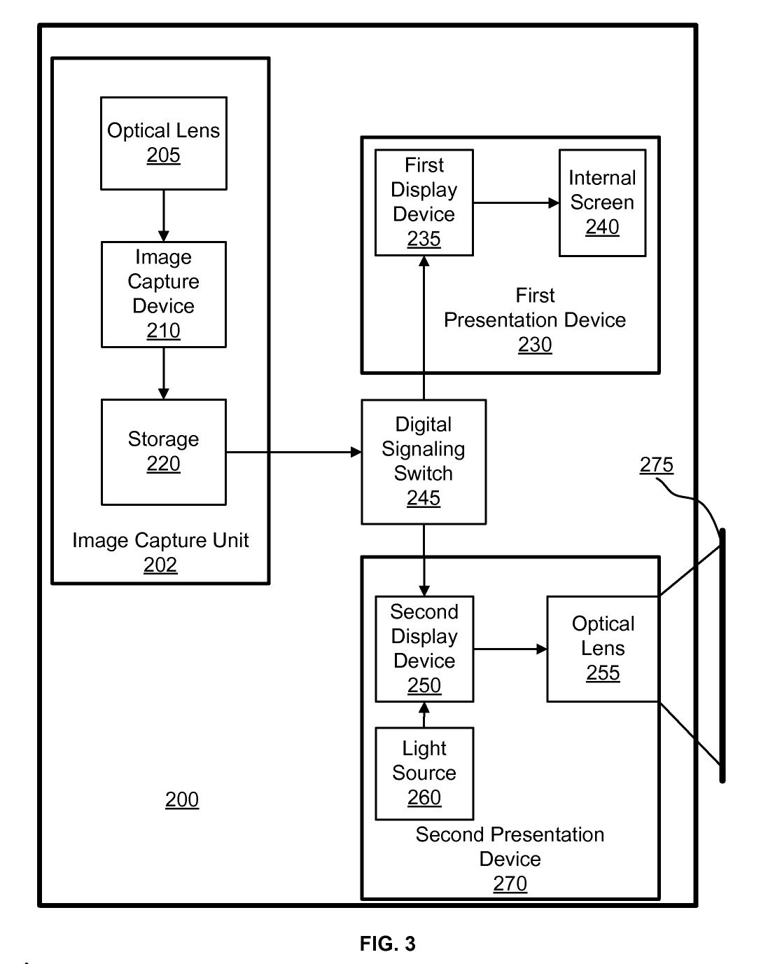

An embodiment of the present invention is illustrated in FIG. 2 (with image processing) and FIG. 3 (without image processing). Shown is an integrated camera-projection device 200 that comprises an image capture unit 202, a digital signaling switch 245, a first presentation device 230 and a second presentation device 270.

The image capture unit 202 captures images and outputs digital representations of the images. One example of an image capture unit 202 is shown in FIG. 2. This image capture unit 202 comprises optical lens 205, an image capture device 210, a compression device 215, storage 220, and a decompression device 225. When the term lens (such as 205, 410 and 415) is mentioned, one will recognize that the lens may be a single lens, a sequence of lenses or an array of lenses, as desired the specific applications. An image capture device 210 may be any image sensing devices, such as a CCD image chip or a CMOS image chip. On source of CMOS Image sensors is Micron Technology, Inc. of Boise, Id. Once an image is captured, the image may be processed and stored in storage 220. Image processing may include image compression 215 and decompression 225 as illustrated in FIG. 2. A compression device 215 takes an image and digitally compresses it into a smaller size, allowing more images to be stored in the same storage 220. When an image is ready to be displayed, the decompression device 225 may receive the image data from storage 220, decompress it and output the image data (or a digital representation of the image). An image can also be stored and outputted without any image processing, as illustrated in FIG. 3. A digital signaling switch 245 may receive the digital representation of an image and selectively output it to the first presentation device 230, the second presentation device 270 or a combination of both. In particular, the first presentation device 230 may be an internal display device and the second display device 270 may be an external projection device in the camera and projection device 200. An example of the first display device 235 is an LCD. An LCD display may be obtained from Kent Displays Incorporated of Kent, Ohio. Alternatively, a MEMs device may be used. MEMs devices may be obtained from Colibrys of Neuchatel, Switzerland, or Texas Instruments of Dallas, Tex. The first presentation device 230 may comprise an internal screen 240 and a first display device 235. The second presentation device 270 may comprise a light source 260, an optical lens 255, and a second display device 250. Display device 235 and 250 may be the same type of device. Display device (235 or 250) may receive the digital representation of an image from the digital signaling switch and project the digital representation optically onto an internal screen 240 or an external screen 250 respectively. Light source 260 may provide light to the second presentation device 270, which may include second display device 250 and optical lens 255, to be projected onto an external screen. The light source can be internal or external. Examples of light sources include Xeon bulbs, LEDs, fluoresecent light sources, incandescent light sources, electrical luminescence light sources and natural lights. Similar to optical lens 205, optical lens 255 may be a single lens or an array of lens.

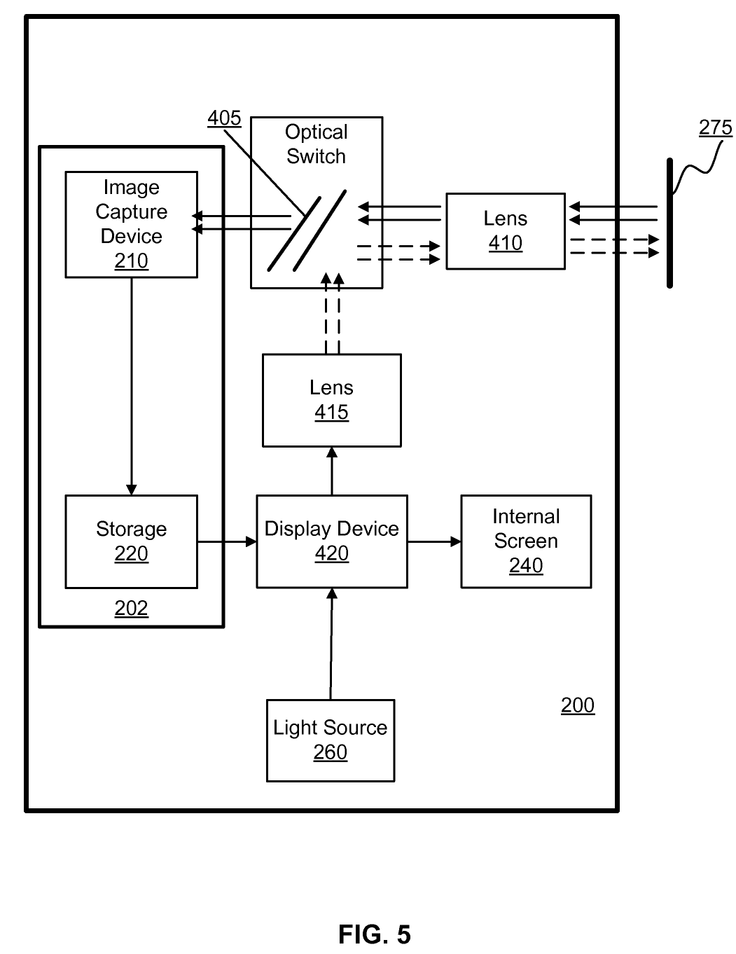

Another embodiment of an integrated camera and projection device 200 is shown in FIG. 4 (with image processing) and FIG. 5 (without image processing). The integrated camera-projection device 200 comprises an image capturing unit 202, a display device 420, a light source 260, an internal screen 240, a focusing lens 415, and an optical switch 405. In this embodiment, light may be transmitted from the outside through lens 410 and focused on an optical switch 405. The optical switch 405 receives the light and transmits it to the image capture unit 202, which in turn may output a digital representation of the image to a displaying device 420. Optical switches may be obtained from Wanshih Electronic Co Ltd. Of Taiwan. As in the previous embodiment of the invention, the image capture unit 202 may store the digital representation of the image with (FIG. 4) or without additional image processing (FIG. 5). The display device 420 may receive the digital representation of the image from the image capture unit 202 and selectively project the image to an internal screen 240. Optionally, the image may be projected externally. In this case, the display device 420 may receive the digital representation of the image from image capture unit 202, and output the digital image optically on lens 415, which in turn focuses it on the optical switch 405. The optical switch 405 may then project the optical image through lens 410 onto an external screen. Depending upon the particular type of technology used for the display device 420, light source 260 may be used to provide illumination.

In this embodiment, lens 410 may replace lens 205 and lens 255. Lens 410 having a first and second side should be capable of transmitting and focusing light on both its first and second sides. Therefore, the same lens 410 may be used in image capture and projection. Conventional auto-focus and zoom cameras generally perform focus and zooming by shifting lens with an electromotor. The motor, together with the lens-slide mechanism, makes the system bulky and vulnerable to shock, wear, or contamination with dirt, dust, sand, or rain. Moreover, a motor consumes electrical power. In addition, as the dimensions shrink, it becomes more difficult to assemble systems like motorized auto-focus cameras that contain moving parts. However, researchers at two companies, Philips Research of Eindhoven, the Netherland and Varioptic of France, have successfully developed a fluid lens or liquid lens which solves these problems. The fluid lens or liquid lens consists of two fluids with different refractive index, one an electrically conducting aqueous solution and the other an electrically non-conducting liquid, contained in a transparent tube. Because the volume of the liquid is constant, charging different voltages to the liquids will cause the curvature of their interface to change. Since the liquids have different refractive indices, their interface can act as a variable-focus lens. Because a liquid lens changes shape instead of position, it should not require a motor. Since liquids are density matched, they are not susceptible to strong impulse forces. The energy to drive the liquid lens may also be extremely low. Lens (such as 410) may employ one or several fluid/liquid lens alone or in combination with conventional lens.

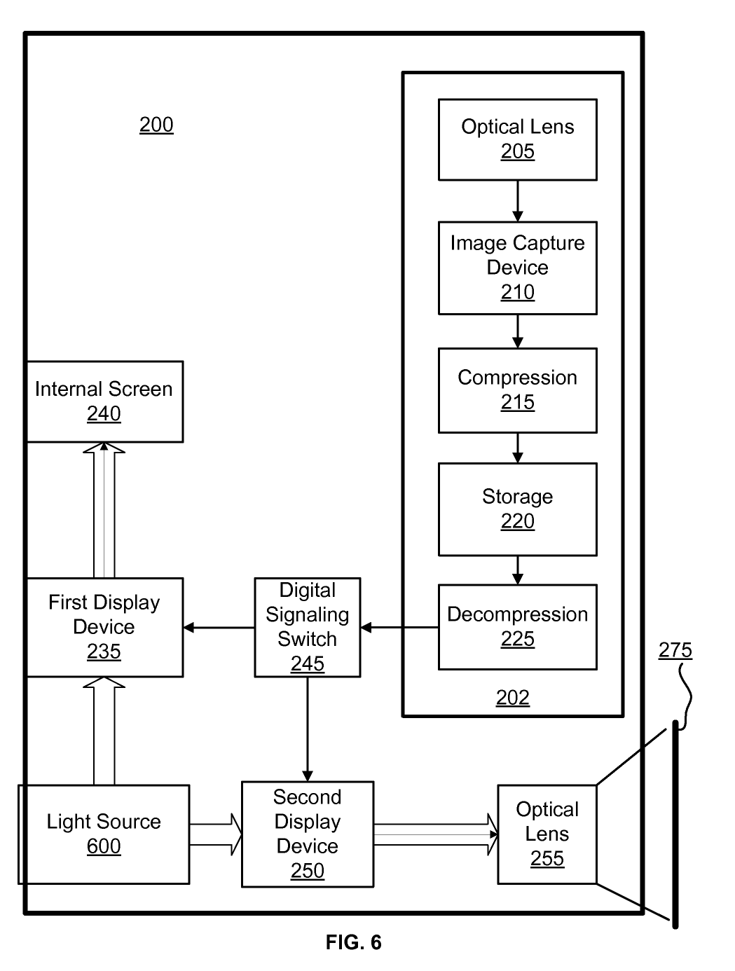

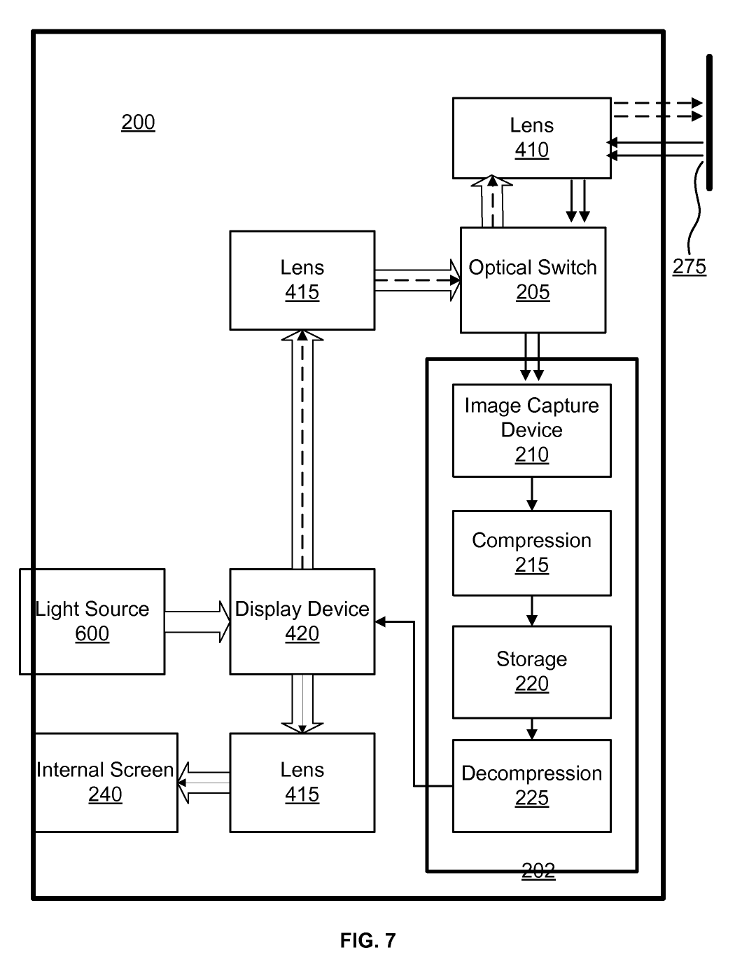

FIGS. 6 and 7 show embodiments of an integrated camera and projection device where the same light source 600 is used for displaying an image on an internal screen and projecting the same image out on an external screen. As in FIG. 6, the light source 600 can be internal or external. Examples of the light source 600 may include a Xeon bulb, an LED, a fluorescent light source, an incandescent light source, an electrical luminescence and natural light. FIG. 6 illustrates the shared light source 600 in an embodiment similar to that shown in FIG. 2. The shared light source 600 can also be used in the embodiment as illustrated in FIG. 3. FIG. 7 illustrates the same light source 600 in an embodiment as shown in FIG. 4. The same light source 600 may also be used in an embodiment as shown in FIG. 5.

In FIG. 6, light source 600 selectively provides light to the second presentation device 270, which comprises a display device 250 and optical lens 255; or to the first presentation device 230, which comprises a display device 240 and internal screen 235. In FIG. 7, light source 600 provides light to the display device 420, which may also receive a digital representation of the image from image capture unit 202, and then output the digital representation of the image optically to either the internal screen 240 or the optical switch 205, which in turn may project the image out through lens 410.

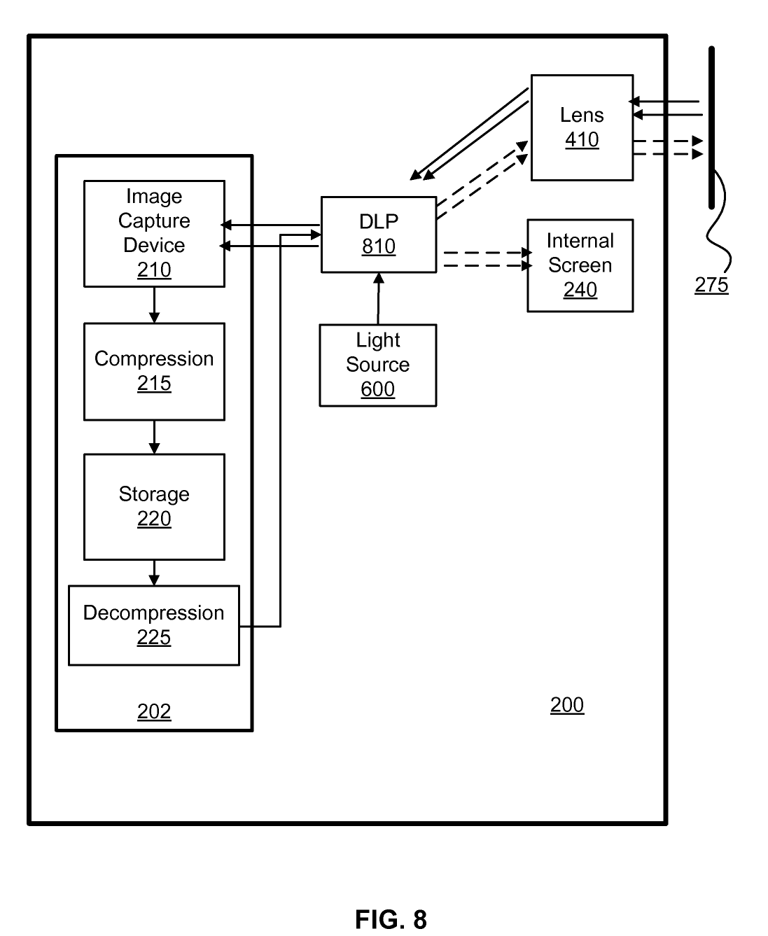

Another embodiment of an integrated camera and projection device is shown on FIG. 8, where a DLP 810 replaces the digital signaling switch 245 and display devices 235 and 250 (as shown in FIGS. 2,3 and 6). The DLP 810 may also replace the display device 420, lens 415 and optical switch 405 (as shown in FIGS. 4, 5, and 7). In this embodiment, lens 410 should be capable of transmitting and focusing light on both its first and second sides. The same light source 300 may be used for either internal display or external projection. To capture an image, light may be transmitted through lens 410, and focused on DLP 810, which then reflects it to the image capture unit 202. To display an image, the image capture unit 202 may output a digital representation of the image to DLP 810. Together with light from light source 600, the digital representation of the image may be projected optically either through lens 410 onto an external screen or directly to an internal screen 240.

The foregoing descriptions of the present invention have been presented for purposes of illustration and description. They are not intended to be exhaustive or to limit the invention to the precise forms disclosed, and obviously many modifications and variations are possible in light of the above teaching. The illustrated embodiments were chosen and described in order to best explain the principles of the invention and its practical application to thereby enable others skilled in the art to best utilize the invention in various embodiments and with various modifications as are suited to the particular use contemplated.

What is claimed is:

1. An integrated camera and projection device comprising:
a) an image capture unit configured to output a digital representation of at least one image;
b) a digital signaling switch configured to:
i) receive said digital representation from said image capture unit; and
ii) selectively output said digital representation to at least one of a multitude of display devices, said display devices including:
(1) a first display device; and
(2) a second display device, said second display device being a projection device;
wherein said first display device and said projection device are integrated in the integrated camera and projection device.

2. The integrated camera and projection device according to claim 1, wherein said first display device comprises a displaying device configured to:
a) receive the digital representation from said digital signaling switch; and
b) project the digital representation as an optical representation onto an internal screen.

3. The integrated camera and projection device according to claim 1, wherein said “first display device” is a LCD screen.

4. The integrated camera and projection device according to claim 1, wherein said “first display device” uses a MEMS device.

5. The integrated camera and projection device according to claim 1, wherein said “second display device” comprises a displaying device configured to:
a) receive the digital representation from said “digital signaling switch”;
b) receive light from a light source; and
c) project said digital representation as an optical representation onto an external screen.

6. The integrated camera and projection device according to claim 1, wherein said “image capture unit” includes at least one of the following devices:
a) an optical lens;
b) an image capture device;
c) a compression device;
d) a storage device; or
e) a decompression device.

7. The integrated camera and projection device according to claim 6, wherein said “image capture device” includes at least one of the following:
a) a CMOS image sensor chip; or
b) a CCD image sensor chip.

8. The integrated camera and projection device according to claim 6, wherein said “image capture device” comprises an image sensing chip.

9. The integrated camera and projection device according to claim 5, wherein said “light source” includes at least one of the following:
a) a Xeon bulb;
b) an LED;
c) a fluorescent light source;
d) an incandescent light source;
e) an electrical luminescence; or
f) a natural light.

10. The integrated camera and projection device according to claim 5, wherein said “light source” selectively provides light to said second display device.

11. The integrated camera and projection device according to claim 5, wherein said “light source” can be internal or external.

12. The integrated camera and projection device according to claim 6, wherein said “lens” includes at least one of the following:
a) a liquid lens; or
b) an optical lens array; or
c) any combination of at least two of the above.

13. An integrated camera and projection device comprising:
a) a lens having a first side and a second side, said lens configured to transmit and focus light on both said first side and said second side;
b) an image capture unit configured to:
i) receive light from an optical switch; and
ii) output an electronic image representation of at least one image, said “image” having first passed through said lens;
c) a displaying device configured to:
i) receive said “electronic image representation” from said “image capture unit”;
ii) receive light from a light source; and
iii) selectively output said “electronic image representation” as an optical image representation to at least one of the following devices:
(1) an internal screen; and
(2) said “optical switch”; and
d) an optical switch configured to selectively route light according to one of the following paths:
i) from said “lens” to said “image capture unit”; and
ii) from said “displaying device” to said “lens”.

14. The integrated camera and projection device according to claim 13, wherein said “optical switch” includes at least one of the following:
a) a mirror;
b) a DLP; or
c) a fiber optic.

15. The integrated camera and projection device according to claim 13, wherein said “light source” includes at least one of the following:
a) Xeon bulb;
b) LED;
c) fluorescent light source;
d) incandescent light source;
e) electrical luminescence; or
f) natural light.

16. The integrated camera and projection device according to claim 13, wherein said “light source” provides light to both said internal screen and said optical switch.

17. The integrated camera and projection device according to claim 13, wherein said “light source” includes at least one of the following:
a) an internal light source; and
b) an external light source.

18. The integrated camera and projection device according to claim 13, wherein said “lens” includes at least one of the following:
a) a liquid lens; and
b) an optical lens array.
